(19) United States
(12) Patent Application Publication
(10) Pub. No.: US 2006/0254786 A1
(43) Pub. Date: Nov. 16, 2006

(54) Impact tool

(76) Inventors: Takuhiro Murakami, Ibaraki (JP); Junichi Kamimura, Ibaraki (JP); Katsuhiro Oomori, Ibaraki (JP); Shinki Ohtsu, Ibaraki (JP); Hiroto Inagawa, Ibaraki (JP); Hideki Watanabe, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/429,278

(22) Filed: May 8, 2006

(30) Foreign Application Priority Data
May 10, 2005 (JP) P2005-137183

(51) Int. Cl. B25D 15/00

(52) U.S. Cl. 173/109; 173/93.5

(57) ABSTRACT

An impact tool includes a rotational impact mechanism which is attached to a spindle 7 rotated and driven by a motor, a rotational impact force generated by the rotational impact mechanism which is intermittently transmitted from a hammer 8 via an anvil 3 to a bit tool 4, thereby giving the rotational impact force to the bit tool 4, and the anvil 3 is provided with a buffer mechanism (rubber damper 13) performing a buffer function in a rotational direction and in an axial direction and also directly transmitting a rotational torque greater than a set value and the spindle 7 is fitted into the anvil 3 and the buffer mechanism (rubber damper 3).

### BACKGROUND OF THE INVENTION

1. Technical Field

The present invention relates to an impact tool for generating a rotational impact force to conduct a predetermined work and in particular relates to an impact tool for preventing a biased abrasion and reducing noise.

2. Description of Related Art

An impact tool, which is a mode of power tools, is driven by a motor to generate a rotational impact force, rotating a bit tool and giving an intermittent impact to it, thereby conducting works such as screw tightening and the like. The impact tool is currently widely used due to characteristics such as a small reaction and a great screw tightening capacity. However, it is provided with a rotational impact mechanism for generating a rotational impact force, thereby causing a great noise in working, which poses a problem.

FIG. 13 illustrates a vertical cross section of a conventional and commonly-used impact tool.

The conventional impact tool illustrated in FIG. 13 is powered by a battery pack 1 and driven by a motor 2 to drive a rotational impact mechanism part, giving a rotation and an impact to an anvil 3, thereby intermittently transmitting a rotational impact force to a bit tool 4 and conducting works such as screw tightening and the like.

In a rotational impact mechanism part built into a hammer case 5, the rotation of a motor 2 on an output axis (motor axis) is reduced via a planetary gear mechanism 6 and transmitted to a spindle 7. Then, the spindle 7 is rotated and driven at a predetermined speed. Herein, the spindle 7 is connected to a hammer 8 via a cam mechanism, and the cam mechanism is constituted with a V-shaped spindle cam groove 7a formed on an outer periphery of the spindle 7, a V-shaped hammer cam groove 8a formed on an inner periphery of the hammer 8 and a ball 9 making an engagement with these cam grooves 7a and 8a.

Further, the hammer 8 is urged constantly toward the leading end by a spring 10 (at the right in FIG. 13) and kept away from the edge surface of an anvil 3 due to the engagement of the ball 9 with the cam grooves 7a and 8a when a tool is stationary, and a convex part is formed symmetrically and respectively at two points on the rotational surface of the hammer 8 and the anvil 3, which are opposed to each other. Additionally, a screw 11, a bit tool 4 and the anvil 3 are mutually restricted in the rotational direction. Further, in FIG. 13, reference numeral 14 denotes a bearing metal which rotatably supports the anvil 3.

Furthermore, when the spindle 7 is rotated and driven as described above, the rotation is transmitted via the cam mechanism to the hammer 8, and a convex part of the hammer 8 is engaged with a convex part of the anvil 3 to rotate the anvil 3 before the hammer 8 is half rotated. When a relative rotation is caused between the hammer 8 and the spindle 7 due to an engaging reaction force generated at that time, the hammer 8 begins to move backward toward the motor 2 along the spindle cam groove 7a of the cam mechanism, while compressing the spring 10. Then, owing to the backward movement of the hammer 8, the convex part of the hammer 8 rides over the convex part of the anvil 3 to release the engagement between them. Consequently, the hammer 8 is rapidly accelerated forward and toward the rotational direction by, in addition to the rotational force of the spindle 7, an elastic energy accumulated in the spring 10 and the action of the cam mechanism, and moved forward by an urging force of the spring 10. Then, the convex part of the hammer is again engaged with the convex part of the anvil 3 to start an integral rotation. Herein, a strong rotational impact force is imparted to the anvil 3, thereby transmitting a rotational impact force to a screw 11 via a bit tool 4 attached on the anvil 3.

Hereinafter, similar motions are repeated to intermittently and repeatedly transmit a rotational impact force from the bit tool 4 to the screw 11, thereby screwing the screw 11 into wood 12 to be tightened.

Incidentally, in performing works in which such an impact tool is used, the hammer 8 provides a back and forth movement, together with a rotational movement. Therefore, these movements generate vibrations, which are then transmitted axially via the anvil 3, the bit tool 4 and the screw 11 to wood 12 which is an object to be tightened, thereby causing a great noise.

It is known that noise energy resulting from an object to be tightened accounts for a substantial percentage of the noise from works related to the use of impact tools. In order to reduce noise, it is necessary to minimize an exciting force transmitted to an object to be tightened, and various measures have been studied for attaining the reduction in noise (refer to JP-A-7-237152 and JP-A-2002-254335, for example).

### SUMMARY OF INVENTION

JP-A-7-237152 has disclosed that an anvil 12 is separated to a rotational impact member 7 and a bit-tool attaching member 8 to form a torque transmitting part 11 between them, thereby placing a buffer material 10 at an axial clearance between them to decrease an axial force acting on a bit tool and a screw and subsequently reduce noise. Herein, the bit-tool attaching member 8 is directly supported by a bearing, but a bit of a spindle 1 is supported only by the rotational impact member 7 supported by the bit-tool attaching member 8.

However, such a constitution may cause a case where the rotational impact member 7 is tilted toward the bit-tool attaching member 8, by which the spindle 1 is also tilted to cause a biased abrasion between the hammer 3 and the rotational impact member 7. In addition, an unnecessary tilt prevents the rotational impact member 7 from being moved axially, thereby resulting in an insufficient effect of noise reduction.

JP-A-2002-254335 has disclosed that parts which can be rolled and moved such as balls and rollers are provided as key elements, grooves formed on both members of an anvil 2 divided into two parts are engaged with the key elements to constitute a torque-transmitting part, thereby reducing an axial friction between these members. Such a constitution also poses a problem similar to that described above.

An object of the present invention is to provide an impact tool which is durable, small in noise and capable of solving the above problem.

In order to achieve the above object, the invention described in Claim 1 is an impact tool, wherein a rotational impact mechanism is attached to a spindle rotated and driven by a motor, a rotational impact force generated by the rotational impact mechanism is intermittently transmitted from a hammer via an anvil to a bit tool, thereby giving the rotational impact force to the bit tool, the impact tool in which the anvil is provided with a buffer mechanism performing a buffer function in a rotational direction and in an axial direction and also directly transmitting a rotational torque greater than a set value and the spindle is fitted into the anvil and the buffer mechanism.

The invention described in Claim 2 is the impact tool described in Claim 1, wherein a range in which the spindle is fitted into the anvil and the buffer mechanism is overlapped in an axial direction with a range in which the anvil is fitted into a bearing metal supporting the anvil.

The invention described in Claim 3 is an impact tool including: a motor, a spindle rotated and driven by the motor, a hammer moving on the spindle in a rotational direction and in an axial direction, an anvil making an engagement/disengagement with the hammer repeatedly in association with the rotation and the axial movement of the hammer, a bearing rotatably supporting the anvil and a bit tool attached to the anvil, the impact tool, wherein the spindle is provided with an axial bit extending to the anvil, and

the anvil is constituted with a first concave/convex part formed in opposition to the hammer, a first divided piece having a first hole part into which the bit of the spindle is inserted,

a second concave/convex part, which is a member for attaching the bit tool, supported rotatably on the bearing and capable of making an engagement with the first concave/convex part in a rotational direction, a second divided piece having a second hole part into which the bit of the spindle is inserted, and

an elastic body placed between the first and the second divided pieces and preventing the first and the second concave convex parts of the first and the second divided pieces from being directly in contact with each other in an axial direction.

The invention described in Claim 4 is the impact tool described in Claim 3, wherein a range in which the bit of the spindle is fitted into the second divided piece of the anvil is overlapped in an axial direction with a range in which the second divided piece is fitted into the bearing.

According to the invention described in Claim 1 or Claim 2, since a buffer mechanism provided on an anvil performs a buffer function in a rotational direction and in an axial direction, axial and rotational vibrations associated with an impact force are absorbed and alleviated by a buffer mechanism to restrain the transmission of axial vibration in particular from the rotational impact mechanism, a source of vibration, to an object to be tightened, thereby realizing the noise reduction. Since the buffer mechanism directly transmits a rotational torque greater than a predetermine value, there is no chance of reducing a tightening capacity.

Further, since the spindle is fitted into the anvil and the buffer mechanism, the buffer mechanism can provide a stable movement to constantly perform a desired buffer function, even when the buffer mechanism, for example, a buffer member such as a rubber damper undergoes a plastic deformation with the elapse of time.

According to the invention described in Claim 3, a bit of a spindle is not only inserted into a first divided piece but also inserted into a second divided piece directly supported by a bearing, thereby making it possible to inhibit an unnecessary tilt of the spindle and also inhibit an unnecessary tilt of the first divided piece inserted into the bit of the spindle accordingly. Therefore, a biased abrasion can be prevented, which takes place between a hammer and the first divided piece, and the first divided piece is allowed to make an axial movement smoothly, reducing noise generated from materials to be tightened. Thus, the invention can provide an impact tool which is durable and small in noise.

According to the invention described in Claim 4, since a range in which a bit is fitted into a second divided piece is overlapped with a range in which the second divided piece is fitted into a bearing, a spindle will be hardly tilted even if the second divided piece is tilted to the bearing, and a first divided piece will be hardly tilted accordingly. As a result, an impact tool is provided, which is more durable and smaller in noise.

### BRIEF DESCRIPTION OF THE DRAWINGS

FIG. 1 is a vertical sectional view illustrating a rotational impact mechanism part of an impact tool in Embodiment 1 of the present invention.

FIG. 2 is an enlarged detailed view of the part A in FIG. 1.

FIG. 3 is an exploded perspective view of the rotational impact mechanism part of the impact tool in Embodiment 1 of the present invention.

FIG. 4 is an exploded perspective view of the rotational impact mechanism part of the impact tool in Embodiment 1 of the present invention.

FIG. 5 is a side view of an anvil of the impact tool in Embodiment 1 of the present invention.

FIGS. 6A, 6B, and 6C are sectional views taken along line B-B in FIG. 5.

FIGS. 7A, 7B, and 7C are views similar to FIGS. 6A-6C which illustrate another mode of a rubber damper.

FIGS. 8A, 8B, and 8C are views similar to FIGS. 6A-6C which illustrate another mode of a rubber damper.

FIGS. 9A, 9B, and 9C are views similar to FIGS. 6A-6C which illustrate another mode of the rubber damper.

FIGS. 10A, 10B, and 10C are views similar to FIGS. 6A-6C which illustrate another mode of the rubber damper.

FIGS. 11A, 11B, and 11C are views similar to FIGS. 6A-6C which illustrate another mode of the rubber damper.

FIGS. 12A, 12B, and 12C are vertical sectional views illustrating a conventional impact tool.

FIG. 13 is a vertical sectional view illustrating a conventional impact tool.

### DESCRIPTION OF THE EMBODIMENTS

Hereinafter, an explanation will be made for embodiments of the present invention by referring to attached drawings.

### Embodiment 1

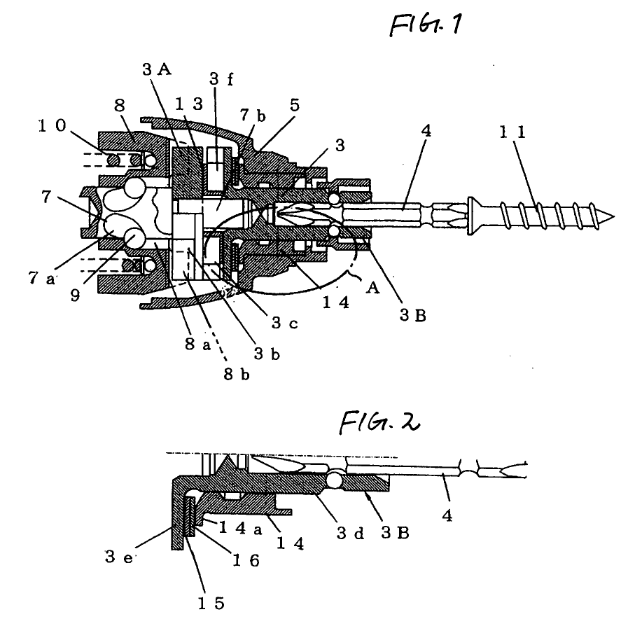

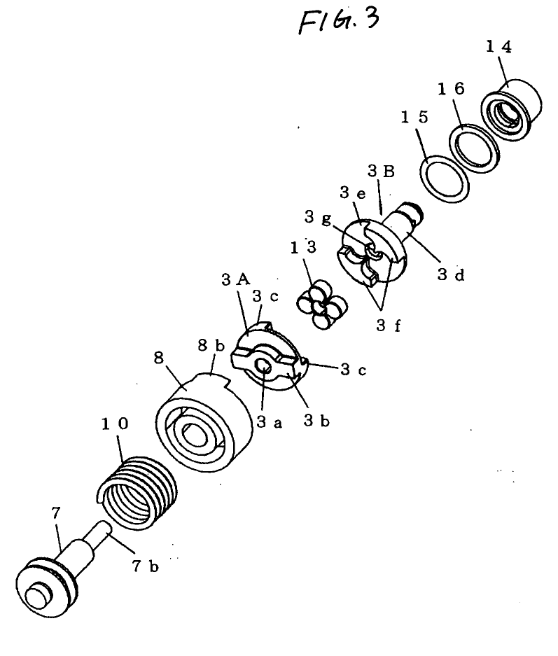

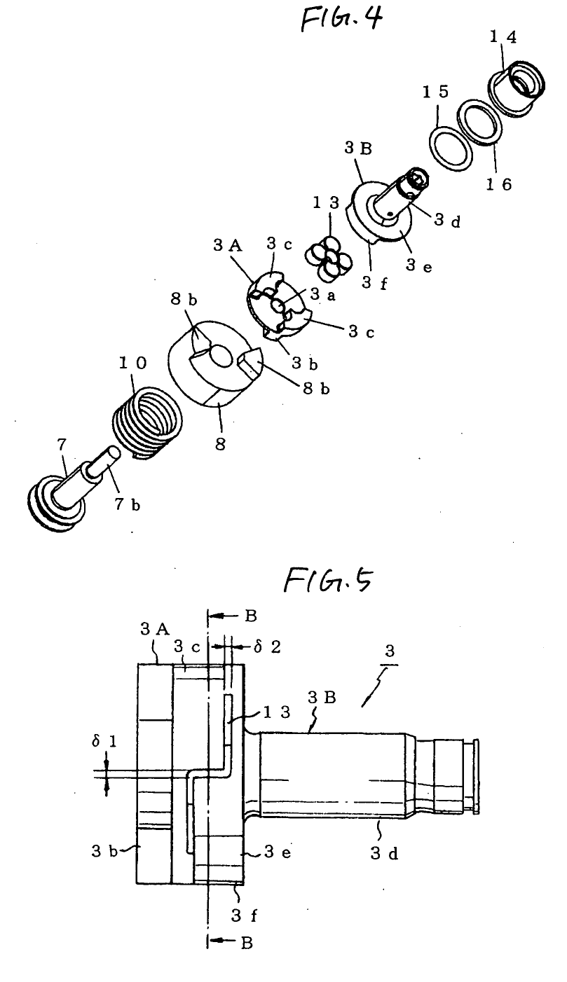

FIG. 1 is a vertical sectional view illustrating a rotational impact mechanism part of an impact tool of the present embodiment. FIG. 2 is an enlarged detailed view of the Part A in FIG. 1, FIG. 3 and FIG. 4 are exploded perspective views of the rotational impact mechanism part of the impact tool, FIG. 5 is a side view of an anvil and FIGS. 6A, 6B, and 6C are sectional views taken along line B-B in FIG. 5.

The impact tool according to the present embodiment is a handheld cordless tool powered by a battery pack and driven by a motor, and constituted similarly as a conventional rotational impact tool illustrated in FIG. 13, with some exceptions. Therefore, in the following explanation, the same constitution as that given in FIG. 13 will be omitted for explanation and only the constitution characteristics in the present invention will be explained.

The impact tool according to the present embodiment is characterized by an anvil 3 provided with a buffer mechanism and a spindle 7 is fitted into the anvil 3 and the buffer mechanism. Herein, the buffer mechanism performs a buffer function in a rotational direction and in an axial direction, and also directly transmits a rotational torque greater than a set value. More specifically, the buffer mechanism is constituted with divided pieces 3A and 3B, which is an anvil 3 divided axially into two parts, and a rubber damper 13 is placed between the divided pieces 3A and 3B as a buffer material. Additionally, as will be described later, the rubber damper 13 also acts as an elastic body for preventing a direct contact of a claw 3c (a first concave/convex part) and an edge surface of an approximately circular plate shaped part of a base of the claw 3c with a claw 3f (a second concave convex part) and an edge surface of a flange part 3e of a base of the claw 3f in a rotational direction and in an axial direction.

One divided piece 3A described above is formed into an approximately circular plate shape and a circular hole 3a is formed at the center thereof. Then, as illustrated in FIG. 3, a linear convex part 3b passing through at the center is formed integrally on the edge surface of the divided piece 3A at the side of a hammer 8. As illustrated in FIG. 4, two fan-shaped convex parts 8b are formed integrally at symmetrical positions apart at an angle of 180 degrees circumferentially on the edge surface at the side of the hammer 8 (on the edge surface opposed to the divided piece 3A), and these convex part 8b is engaged or disengaged with a convex part 3b formed by one divided piece 3A described above intermittently for every reverse rotation, as will be described later. Further, as illustrated in FIG. 4 through FIG. 6C, two claws 3c are formed integrally at symmetrical positions apart at an angle of 180 degrees circumferentially on the other edge surface of the divided piece 3A (on the edge surface opposed to the other divided surface 3B), and two concave parts 3-1 are formed in the shape of arch at each of the claws 3c (refer to FIGS. 6A, 6B, and 6C) Additionally, a circular hole 8c is penetrated and provided at the center of the hammer 8.

Herein, since a convex part 8b of a hammer 8 is engaged and disengaged with a convex part 3b of a divided piece 3A as will be described later, the divided piece 3A will act as a first divided piece which is repeatedly engaged and disengaged with the hammer 8. A first concave/convex part is formed by a claw 3c and an edge surface of an approximately circular plate shaped part, which is a base of the claw 3c.

Further, the other divided piece 3B is constituted by integrally forming a circular plate shaped flange part 3e at one edge of a hollow axial part 3d at a direction orthogonal to the axis. As illustrated in FIG. 3, FIG. 5 and FIGS. 6A-6C, two claws 3f similar to the claws 3c at the side of the divided piece 3A are formed integrally at symmetrical positions apart at an angle of 180 degrees circumferentially on the edge surface of the flange part 3e (on the edge surface opposed to the divided piece 3A), and two concave parts 3f-1 are formed in the shape of an arch at each of the claws 3f (refer to FIGS. 6A-6C). Herein, the divided piece 3B will act as a second divided piece with respect to a first divided piece. Then, a second concave convex part capable of making an engagement with the first concave/convex part in a rotational direction is formed by a claw 3c and an edge surface of a flange part 3e, which is a base of the claw 3c.

Further, as illustrated in FIG. 3, FIG. 4 and FIGS. 6A-6C, the rubber damper 13 is constituted by arranging integrally four cylindrical damper pieces 13b circumferentially at an equal-angle pitch (90° pitch) around a circular hole 13a formed at the center.

Furthermore, as illustrated in FIG. 1, an anvil 3 is housed inside a hammer case 5, with an axial part 3d of the divided piece 3B being rotatably supported by a bearing metal 14. The rubber damper 13 is placed on an edge surface 3e of a flange part of the divided piece 3B, and the other divided piece 3A is assembled in such a way that these claws 3c and 3f are arranged alternately in a circumferential direction as illustrated in FIGS. 6A-6C. The divided piece 3A is supported by a bit 7b of a spindle 7 inserted and penetrated into a circular hole 3a formed at the center so as to make a relative rotation with the divided piece 3B.

Herein, the bit 7b of the spindle 7 penetrates through the circular hole 3a of the divided piece 3A and the circular hole 13a of the rubber damper 13, and is fitted into the circular hole 3g of the other divided piece 13B in a loosely fitted manner. A range in which the bit is fitted is overlapped in an axial direction with a range in which the anvil 3 is fitted into a bearing metal 14 supporting the anvil, as illustrated in FIG. 1. That is, the circular hole 3a will act as a first hole part inserted into the bit 7b of the spindle 7, and the circular hole 3g will act as a second hole part inserted into the bit 7b of the spindle 7.

Further, as illustrated in FIG. 2, a metal ring 15 and a rubber ring 16 for receiving a thrust are installed between the back surface of the flange part 3e at the divided piece 3B of the anvil 3 and a flange part 14a on the edge surface of the bearing metal 14.

As described above, in a state where the anvil 3 is housed inside the hammer case 5, a space is formed along an outer configuration of a rubber damper 13 by claws 3c and 3f arranged alternately at these divided pieces 3A and 3B in the circumferential direction, and the rubber damper 13 is fitted and housed into the space, as illustrated in FIGS. 6A-6C.

Furthermore, in a load-free state where no rotational impact force acts on the anvil 3, as illustrated in FIG. 5 and FIG. 6A, a circumferential clearance δ1 is formed between the claws 3c and 3f of the divided pieces 3A and 3B, and an axial clearance δ2 is also formed (refer to FIG. 5).

Then, a bit tool 4 is attached to an axial part 3d of the divided piece 3B of the anvil 3 in an attachable and detachable manner. A hammer 8 having a convex part 8b, which is engaged and disengaged with the convex part 3b formed on an outer edge surface of the divided piece 3A, is constantly urged to the anvil 3 (to the leading end) by a spring 10.

Next, an explanation will be made for an action of the above-constituted impact tool.

At a rotational impact mechanism part, the rotation of an output axis (motor axis) of a motor is reduced through a planetary gear mechanism and transmitted to a spindle 7, by which the spindle 7 is rotated and driven at a predetermined speed. As the spindle 7 is rotated and driven, the rotation is transmitted via a cam mechanism and transmitted to a hammer 8. Before the hammer 8 is half rotated, the convex part 8b of the hammer is engaged with the convex part 3b of a divided piece 3A of an anvil 3, thereby rotating the divided piece 3A.

When the reaction force (engaging reaction force) resulting from engagement of the convex part 8b of the hammer 8 with the convex part 3b of the divided piece 3A of the anvil 3 causes a relative rotation between the hammer 8 and the spindle 7, the hammer 8 will begin to move backward to a motor, while compressing a spring 10 along a spindle cam groove 7a of a cam mechanism. The convex part b of the hammer 8 rides over the convex part 3b of the divided piece 3A of the anvil 3 to release the engagement between them, owing to the backward movement of the hammer 8. Then, the hammer 8 is rapidly accelerated forward and toward the rotational direction by the rotational force of the spindle 7, an elastic energy accumulated in the spring 10 and the action of the cam mechanism, and moved forward by an urging force of the spring 10. Then, the convex part 8b of the hammer 8 is again engaged with the convex part 3b of the anvil 3 to start the rotation of the anvil 3. Herein, a strong rotational impact force is imparted to the anvil 3. However, since the anvil 3 is constituted by placing a rubber damper 13 between two divided pieces 3A and 3B and an axial clearance δ2 is formed between these two divided pieces 3A and 3B as illustrated in FIG. 5, an impact vibration is absorbed and reduced by an axial elastic deformation of the rubber damper 13 resulting from the impact force.

Hereinafter, similar motions are repeated to intermittently and repeatedly transmit a rotational impact force from the bit tool 4 to the screw 11, thereby screwing the screw 11 into wood to be tightened.

Furthermore, in the impact tool of the present embodiment, since a buffer mechanism provided on the anvil 3 performs a buffer function in a rotational direction and in an axial direction, axial and rotational vibrations resulting from an impact force are absorbed and alleviated by the buffer mechanism to restrain the transmission of axial vibration in particular from the rotational impact mechanism which is a source of vibration, to wood, thereby realizing noise reduction.

The buffer mechanism allows a claw 3c of the divided piece 3A of the anvil 3 to be directly in contact with a claw 3f of the other divided piece 3B with respect to a rotational torque greater than a set value (refer to FIG. 6B), and these divided pieces 3A and 3B directly transmit in an integral manner a rotational torque greater than a set value to the bit tool 4 and the screw 11 and rotate them, thereby making it possible to prevent a decrease in tightening capacity.

Therefore, according to the impact tool of the present embodiment, it is possible to realize noise reduction, without causing a decrease in tightening capacity.

Further, as described above, the bit 7b of the spindle 7 penetrates through the circular hole 3a of the divided piece 3A and the circular hole 13a of the rubber damper 13, and is fitted into the circular hole 3g of the other divided piece 13B. Therefore, a range in which the bit is fitted is overlapped in an axial direction with a range in which the anvil 3 is fitted into a bearing metal 14 supporting the anvil, as illustrated in FIG. 1. When the rubber damper 13 of the buffer mechanism undergoes a plastic deformation with the elapse of time, the buffer mechanism can provide a stable movement to perform a desirable function constantly. In this case, since the bit 7b of the spindle 7 is fitted into the circular hole 3a of the divided piece 3A, the circular hole 13a of the rubber damper 13 and the circular hole 3g of the divided piece 3B in a loosely fitted manner, the buffer mechanism works stably to reduce noise for a long time, without posing problems such as scoring.

Furthermore, when the present embodiment is viewed differently, the bit 7b of the spindle 7 is not only inserted into the divided piece 3A but also inserted into the divided piece 3B directly supported by a bearing metal 14, thereby making it possible to decrease an unnecessary tilt of the spindle 7 and also decrease an unnecessary tilt of the divided piece 3B inserted into the bit 7b of the spindle 7 accordingly. Therefore, a biased abrasion can be prevented, which takes place between the convex part 8b of the hammer 8 and the convex part 3b of the divided piece 3A, and the divided piece 3A is allowed to make an axial movement smoothly, and thereby minimize noise generated from materials to be tightened.

In addition, since a range in which the bit 7b of the spindle 7 is fitted into the divided piece 3B is overlapped with a range in which the divided piece 3B is fitted into the bearing metal 14, the spindle 7 will be hardly tilted even if the divided piece 3B is tilted to the bearing metal 14, and the divided piece 3A will be hardly tilted accordingly.

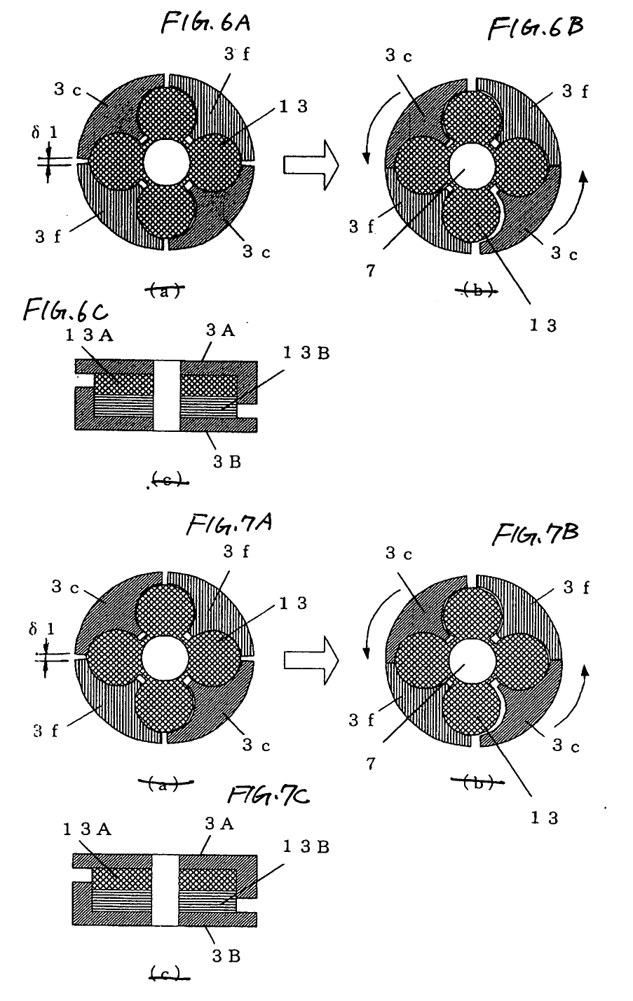

Herein, various modes of the rubber damper as a buffer material are illustrated in FIG. 7A through FIG. 12C. Additionally, FIG. 7A through FIG. 12C are similar to FIG. 6A denotes a load-free state; FIG. 6B, a load state on which a rotational torque greater than a set value acts; FIG. 6C, a cross section of the rubber damper.

In a mode illustrated in FIGS. 7A-7C, the rubber damper 13 is formed similarly as that illustrated in FIGS. 6A-6C. However, as illustrated in FIG. 7C, the rubber damper 13 is constituted by laminating two-layers of elastic bodies 13A and 13B different in spring constant in an axial direction (vertical direction in FIG. 7C). Therefore, characteristics of the rubber damper 13 may be changed arbitrarily, for example, a case where the spring constant of the rubber damper 13 in a rotational direction is set to be greater than that in an axial direction.

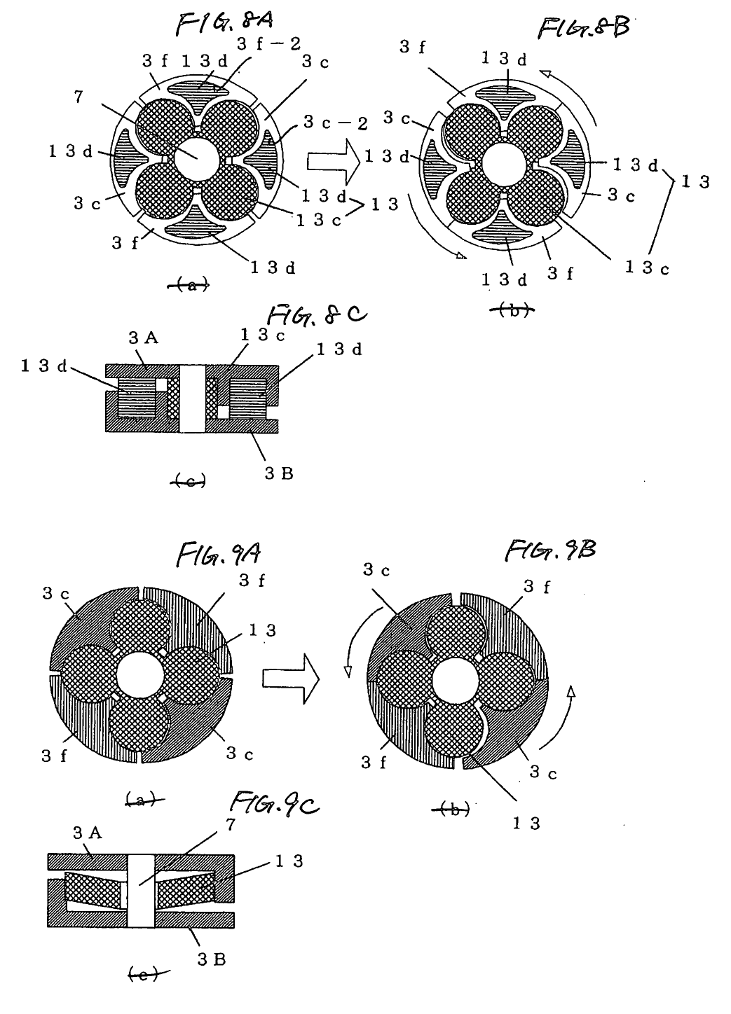

In a mode illustrated in FIGS. 8A-8C, the rubber damper 13 is constituted with a total of four elastic bodies 13d fitted into approximately fan-shaped holes 3c-2 and 3f-2 formed at each of claws 3c and 3f of the divided pieces 3A and 3B of the anvil 3, in addition to an elastic body 13c having a configuration similar to that illustrated in FIGS. 6A-6C. Herein, the elastic body 13c and the elastic body 13d may be identical or different in spring constant. Characteristics of the rubber damper 13 may be changed, depending on the necessity, for example, a case where the spring constant of the elastic body 13d which does not contribute to the transmission of rotation is set to be smaller than that of the elastic body 13c which contributes to the transmission of rotation, by which the spring constant of the rubber damper 13 in a rotational direction as a whole is set to be greater than that in an axial direction.

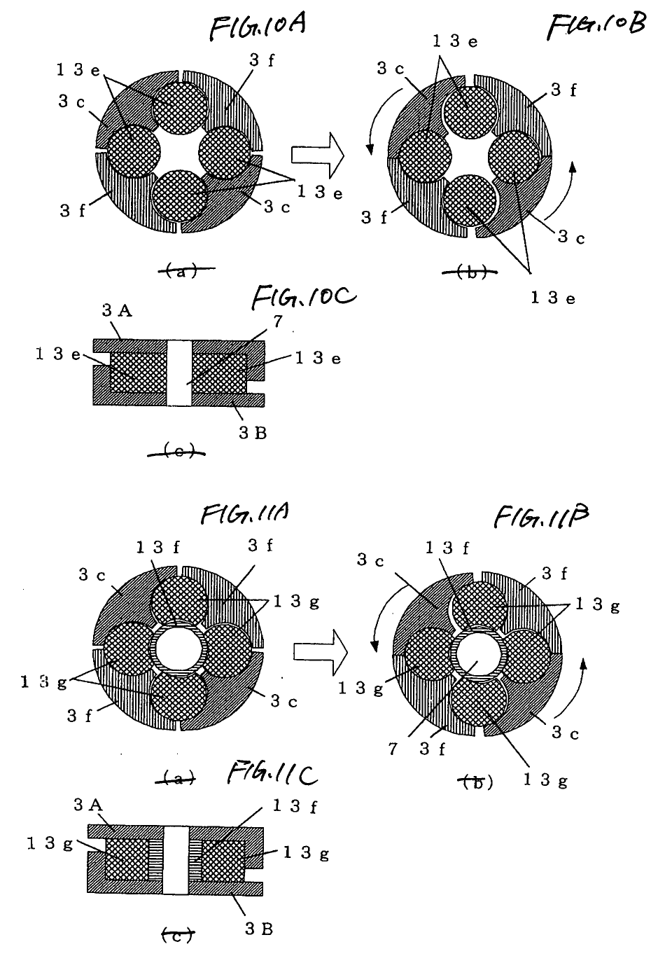

Further, in a mode illustrated in FIGS. 9A-9C, the rubber damper 13 similar in configuration when viewed from an axial direction as that illustrated in FIGS. 6A-6C is formed into a disk-spring shape easily deformable in an axial direction, as illustrated in FIG. 9C. Therefore, the spring constant of the rubber damper 13 in a rotation direction can be set to be greater than that in an axial direction.

In a mode illustrated in FIGS. 10A-10C, the rubber damper 13 is constituted with four independent cylindrical elastic bodies 13e. When a transmitted torque of the divided piece 3A of the anvil 3 exceeds a set value, as illustrated in FIG. 10B, the rubber damper 13 undergoes an elastic deformation, and a claw 3c of one divided piece 3A is in contact with a claw 3f of the other divided piece 3B (metal-to-metal contact). Thereby, the rotational torque is directly transmitted from one divided piece 3A to the other divided piece 3B, and the anvil 3 rotates in an integrated manner to transmit the rotation to the bit tool 4. In this case, since four elastic bodies 13e constituting the rubber damper 13 are formed independently of each other, the spring constant can be set individually to change characteristics of the rubber damper 13 as a whole, depending on the necessity.

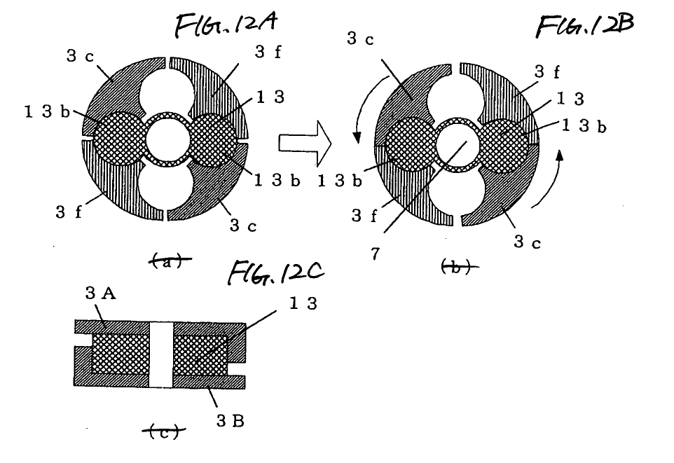

In a mode illustrated in FIGS. 11A-11C, the rubber damper 13 is constituted with a sleeve-shaped elastic body 13f at the center and four independent elastic bodies 13g arranged in the vicinity. When a transmitted torque of the divided piece 3A of the anvil 3 exceeds a set value, as illustrated in FIG. 11B, the rubber damper 13 undergoes an elastic deformation, and a claw 3c of one divided piece 3A is in contact with a claw 3f of the other divided piece 3B (metal-to-metal contact) Thereby, the rotational torque is directly transmitted from one divided piece 3A to the other divided piece 3B, and the anvil 3 rotates in an integrated manner to transmit the rotation to the bit tool 4. In this case as well, since one elastic body 13f and four elastic bodies 13g constituting the rubber damper 13 are formed independently of each other, the spring constant can be set individually to change characteristics of the rubber damper 13 as a whole, depending on the necessity.

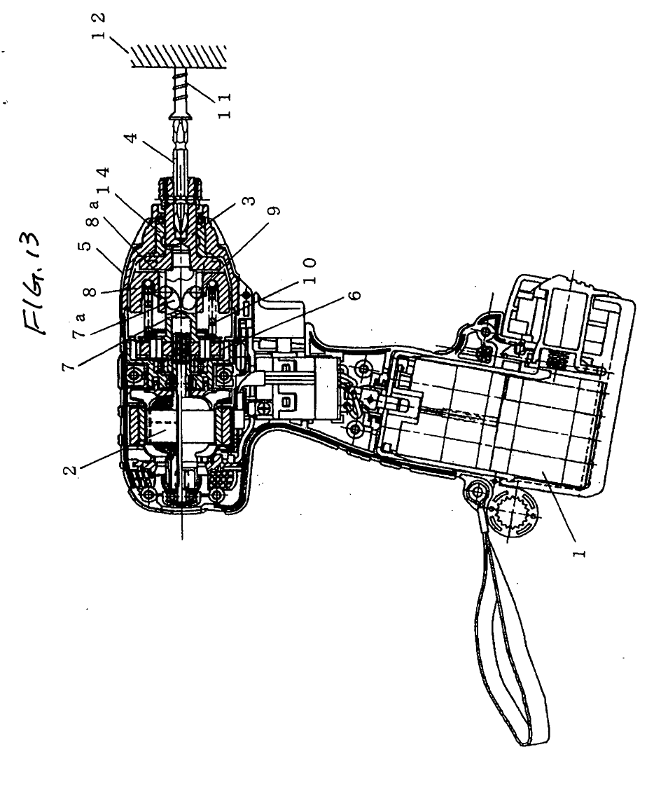

Further, in a mode illustrated in FIGS. 12A-12C, the number of cylindrical damper pieces 13b constituting the rubber damper 13 is decreased to two pieces, and these damper pieces 13b are arranged integrally at symmetrical positions apart at an angle of 180 degrees circumferentially. This mode can be effectively used in applications where no great transmitted torque is needed in particular.

The rubber damper used in a rotational impact tool of the present invention may include any damper which performs a buffer function both in an axial direction and in a rotational direction and also prevents the divided pieces of an anvil from being directly in contact with each other in an axial direction during operation of an actual machine, or acts in such a way that a claw of one divided piece is directly brought into contact with a claw of the other divided piece when a rotational torque greater than a set value is applied in a circumferential direction. It is, therefore, possible to change the thickness of a rubber damper or the angle of a claw of a divided piece of an anvil according to a product specification, thereby making it possible to obtain appropriate characteristics. Where no problem is posed by setting a transmitted torque at a low level in view of the product specification, the angle of the claws may be set greater so that the claws are prevented from being directly in contact with each other in a circumferential direction.

The present invention is applicable to an impact tool such as a hammer drill for generating a rotational impact force to conduct a predetermined work and particularly effective in reducing noise.

What is claimed is:

1. An impact tool comprising;
a motor;
a spindle rotated and driven by the motor; and
a rotational impact mechanism attached to the spindle, the rotational impact mechanism generating a rotational impact force which is intermittently transmitted from a hammer via an anvil to a bit tool, thereby giving the rotational impact force to the bit tool,
wherein the anvil comprises a buffer mechanism performing a buffer function in a rotational direction and in an axial direction and directly transmitting a rotational torque greater than a set value, and
wherein the spindle is fitted to the anvil and the buffer mechanism.

2. The impact tool as set forth in claim 1, wherein a range in which the spindle is fitted into the anvil and the buffer mechanism is overlapped in an axial direction with a range in which the anvil is fitted into a bearing metal supporting the anvil.

3. An impact tool comprising:
a motor;
a spindle rotated and driven by the motor;
a hammer moving on the spindle in a rotational direction and in an axial direction;
an anvil making an engagement/disengagement with the hammer repeatedly in association with the rotation and the axial movement of the hammer;
a bearing supporting rotatably the anvil and a bit tool attached to the anvil;
wherein the spindle is provided with an axial bit extending to the anvil,
wherein the anvil comprises;
a first concave/convex part formed in opposition to the hammer;
a first divided piece having a first hole part into which the bit of the spindle is inserted;
a second concave/convex part, which is a member for attaching the bit tool, supported rotatably on the bearing and capable of making an engagement with the first concave/convex part in a rotational direction;
a second divided piece having a second hole part into which the bit of the spindle is inserted, and
an elastic body placed between the first and the second divided pieces and preventing the first and the second concave convex parts of the first and the second divided pieces from being directly in contact with each other in an axial direction.

4. The impact tool as set forth in claim 3, wherein a range in which the bit of the spindle is fitted into the second divided piece of the anvil is overlapped in an axial direction with a range in which the second divided piece is fitted into the bearing.
